(19) United States
(12) Patent Application Publication
(10) Pub. No.: US 2014/0267095 A1
(43) Pub. Date: Sep. 18, 2014

(54) ELECTRONIC DEVICE WITH FUNCTION FOR SEARCHING FOR ICONS REPRESENTING APPLICATIONS AND METHOD THEREOF

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHENG-QIANG CAI, Shenzhen (CN); JUN-NAN FAN, Shenzhen (CN); YING-XIONG HUANG, New Taipei (TW)

(21) Appl. No.: 13/945,906

(22) Filed: Jul. 19, 2013

(30) Foreign Application Priority Data
Mar. 14, 2013 (CN) 201310081779X

(51) Int. Cl. G06F 3/041; G06F 3/0481

(52) U.S. Cl. CPC G06F 3/041; G06F 3/04817
USPC 345/173

(57) ABSTRACT

A method for searching for icons relating to applications in an electronic device is computer-implemented. When a currently displayed interface of the electronic device is an application icon interface including a plurality of icons, an input touch is determined to be either an already-recorded user-defined touch or a system-defined touch. System-defined touches have automatic consequences. A relationship table is searched to find one or more icons related to the input touch when the input touch is determined to be a previously-recorded user-defined touch. A window is displayed to simultaneously show one or more found icons on the touch screen for the convenience of the user, avoiding any page-up or page-down operation.

### BACKGROUND

1. Technical Field

The present disclosure relates to electronic devices, and particularly to an electronic device capable of searching for icons representing applications and a method thereof.

2. Description of Related Art

Electronic devices (e.g. smartphones) include a number of applications and icons representing the applications. The size of a touch screen of such an electronic device is limited, thus icons may be distributed in across screens or different parts of a single display. Thus, it needs users to page up or page down to find needed icons, which is time-consuming.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of an electronic device with a function of searching for icons representing applications of the electronic device, in accordance with an exemplary embodiment.

FIG. 2 is a block diagram of a searching system of FIG. 1, in accordance with an exemplary embodiment.

FIG. 3 is a schematic view of an interface provided by the searching system of FIG. 1, in accordance with an exemplary embodiment.

FIG. 4 is a flowchart of a method for searching for one or more icons representing applications, in accordance with an exemplary embodiment.

FIG. 5 is a flowchart of a method for relating an input touch executed on a touch screen of the electronic device to one or more icons representing applications, in accordance with an exemplary embodiment.

### DETAILED DESCRIPTION

Embodiments of the present disclosure are described, with reference to the accompanying drawings.

Referring to FIG. 1, an embodiment of an electronic device 100 includes a touch screen 10, a storage unit 20, and a processor 30. The electronic device 100 may be a smart phone or a tablet. The storage unit 20 stores a user-defined touch database, a relationship table recording relationships between user-defined touches and icons representing applications, and a number of modules of a searching system 40. In the relationship table, each user-defined touch is related to one or more icons representing applications. In this embodiment, the electronic device 100 divides input touches executed on the touch screen 10 into a type of user-defined touches and a type of system-defined touches. The system-defined touches control the electronic device 100 to execute preset functions, for example, open an application. The system-defined touches may include tapping on the touch screen 10, and sliding a finger towards right or left. The searching system 40 is executed by the processor 30 to search for one or more icons related to an input user-defined touch.

Referring to FIG. 2, the searching system 40 includes a touch determining module 42, a searching module 43, a display control module 44, an executing module 45, and a setting module 46.

The touch determining module 42 determines whether an input touch executed on the touch screen 10 is a user-defined touch recorded in the user-defined touch database or a system-defined touch, when a currently displayed interface of the electronic device 100 is an icon interface including a number of icons representing applications.

The searching module 43 searches within the relationship table to find one or more icons related to the input touch when the input touch is a user-defined touch.

The display control module 44 displays a window to simultaneously show one or more found icons on the touch screen 10. When one found icon in the window is tapped, the application corresponding to the icon is opened and run. With such configuration, users can quickly find needed icons.

The executing module 45 executes a preset function when the input touch is a system-defined touch.

The setting module 46 warns that an input touch is not related to any icon when the input touch is neither a user-defined touch nor a system-defined touch, and displays options for users to select whether to relate any new or unknown input touch to one or more icons. The setting module 46 further displays a relation interface 462 (see FIG. 3) for users to relate an input touch to one or more icons when users select to relate such input touch to one or more icons. The relation interface 462 includes a touch input area 4622 and an application selection area 4624. The touch input area 4622 is for users to input a touch. When a selection button 4626 is tapped, a list of applications of the electronic device 100 is displayed for users to select. The selected applications are displayed in the application selection area 4624. When one application in the application selection area 4624 is selected, the icon representing the selected application is related to a new recognizable touch input through the touch input area 4622.

In this embodiment, when the touch determining module 42 determines that the input touch input through the touch input area 4622 is already recorded in the user-defined touch database, or that is a system-defined touch, the setting module 46 warns that the input touch input through the touch input area 4622 is not an available touch. Further, when the touch determining module 42 determines that the input touch input through the touch input area 4622 is unrecognizable because of size, or complexity, or because of unrepeatablity, the setting module 46 warns that the input touch input through the touch input area 4622 cannot be recognized.

FIG. 4 is a flowchart of a method for searching for icons representing applications, in accordance with an exemplary embodiment.

In step S402, the touch determining module 42 determines whether an input touch is a user-defined touch already recorded in the user-defined touch database or is a system-defined touch, when the currently displayed interface of the electronic device 100 is the icon interface. When the input touch is a user-defined touch which is recorded, step S403 is executed. When the input touch is a system-defined touch, step S405 is executed. When the input touch is neither a recorded user-defined touch nor a system-defined touch, step S406 is executed.

In step S403, the searching module 43 searches within the relationship table to find one or more icons related to the input touch.

In step S404, the display control module 44 displays a window to simultaneously show one or more found icons.

In step S405, when the input touch is a system-defined touch, the executing module 45 executes a preset function.

In step S406, when the input touch is determined to be neither a recorded user-defined touch nor a system-defined touch, the setting module 46 warns that the input touch is not related to any icon, and displays options for users to select whether to relate such a new or unknown input touch to one or more icons.

FIG. 5 is a flowchart of a method for relating an input touch to one or more icons, in accordance with an exemplary embodiment.

In step S500, the setting module 46 displays the interface 462. The interface 462 includes the touch input area 4622 and the application selection area 4624.

In step S501, the touch determining module 42 determines whether the input touch input through the touch input area 4622 can be recognizable. If yes, step S502 is executed, otherwise, step S503 is executed.

In step S502, the setting module 46 warns that the input touch cannot be recognized, for reasons of size or otherwise.

In step S503, the touch determining module 42 determines whether the input touch is a recorded user-defined touch or a system-defined touch. When the input touch is neither a recorded user-defined touch nor a system-defined touch, step S504 is executed, otherwise, step S505 is executed.

In step S504, the setting module 46 relates the new or unknown input touch to one or more icons representing the selected applications selected through the application selection area 4624.

In step S505, the setting module 46 warns that the input touch made is not available to be used.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a touch screen;
a storage unit storing a user-defined touch database, a relationship table recording relationships between user-defined touches and icons representing applications of the electronic device, and a plurality of modules of a searching system, wherein, in the relationship table, each user-defined touch of the user-defined touch database is related to one or more of the icons; and
a processor to execute the plurality of modules of the searching system to perform operations of searching for one or more of the icons representing applications of the electronic device, the operations comprising:
determining whether an input touch is a user-defined touch recorded in the user-defined touch database when a currently displayed interface of the electronic device is an icon interface;
searching within the relationship table to find one or more icons related to the input touch when the input touch is a user-defined touch recorded in the user-defined touch database; and
displaying a window to show the one or more found icons on the touch screen.

2. The electronic device as described in claim 1, wherein the operations further comprising:
determining whether the input touch is a system-defined touch when the input touch is not a user-defined touch recorded in the user-defined touch database; and
executing a preset function when the input touch is a system-defined touch.

3. The electronic device as described in claim 2, wherein the operations further comprising:
warning that the input touch is not related to any icon when the input touch is neither a user-defined touch recorded in the user-defined touch database nor a system-defined touch;
displaying options for users to select whether to relate a new input touch to one or more icons; and
displaying a relation interface for users to relate a new input touch to one or more icons when users select to relate a new input touch to one or more icons, the relation interface comprising a touch input area and an application selection area, the touch input area being for users to input a touch, and the application selection area being for users to select one or more applications; and
relating a new input touch input through the touch input area to one or more icons representing one or more selected applications when such new touch input is recognizable, and is neither a use-defined touch recorded in the user-defined touch database nor a system-defined touch.

4. The electronic device as described in claim 3, wherein the operations further comprising:
warning that an input touch input through the touch input area is unrecognizable when the touch input is unrecognizable.

5. The electronic device as described in claim 3, wherein the operations further comprising:
warning that an input touch input through the touch input area is unavailable when the input touch is a user-defined touch recorded in the user-defined touch database or a system-defined touch.

6. A computer-implemented method for searching icons of an electronic device, comprising:
determining whether an input touch is a user-defined touch recorded in a user-defined touch database when a currently displayed interface of the electronic device is an icon interface;
searching within a relationship table to find one or more of the icons related to the input touch when the input touch is a user-defined touch recorded in the user-defined touch database, wherein, in the relationship, each user-defined touch recorded in the user-defined touch database is related to one or more of the icons; and
displaying a window to show the one or more found icons on the touch screen.

7. The method as described in claim 6, further comprising:
determining whether the input touch is a system-defined touch when the input touch is not a user-defined touch recorded in the user-defined touch database; and
executing a preset function when the input touch is a system-defined touch.

8. The method as described in claim 7, further comprising:
warning that the input touch is not related to any application icon when the input touch is neither a user-defined touch recorded in the user-defined touch database nor a system-defined touch;
displaying options for users to select whether to relate a new input touch to one or more icons; and
displaying a relation interface for users to relate a new input touch to one or more icons when users select to relate a new input touch to one or more icons, the relation interface comprising a touch input area and an application selection area, the touch input area being for users to input a touch, and the application selection area being for users to select one or more applications; and
relating a new input touch input through the touch input area to one or more icons representing one or more selected applications when such new touch input is recognizable, and is neither a user-defined touch recorded in the user-defined touch database nor a system-defined touch.

9. The method as described in claim 8, further comprising:
warning that an input touch input through the touch input area is unrecognizable when the input touch is unrecognizable.

10. The method as described in claim 8, further comprising:
warning that an input touch input through the touch input area is unavailable when the input touch is a user-defined touch recorded the user-defined touch database or a system-defined touch.

11. A computer-readable storage medium encoded with a computer program, the program comprising instructions that when executed by one or more computers cause the one or more computers to perform operations of searching icons of an electronic device, the operations comprising:
determining whether an input touch is a user-defined touch of a user-defined touch database when a currently displayed interface of the electronic device is an icon interface;
searching within a relationship table to find one or more of the icons related to the input touch when the input touch is a user-defined touch recorded in the user-defined touch database, wherein, in the relationship, each user-defined touch recorded in the user-defined touch database is related to one or more of the icons; and
displaying a window to show the one or more found icons on the touch screen.

12. The storage medium as described in claim 11, wherein the operations further comprising:
determining whether the input touch is a system-defined touch when the input touch is not a user-defined touch recorded in the user-defined touch database; and
executing a preset function when the input touch is a system-defined touch.

13. The storage medium as described in claim 12, wherein the operations further comprising:
warning that the input touch is not related to any application icon when the input touch is neither a user-defined touch recorded in the user-defined touch database nor a system-defined touch;
displaying options for users to select whether to relate an input touch to one or more icons; and
displaying a relation interface for users to relate the input touch to one or more icons when users select to relate an input touch to one or more icons, the relation interface comprising a touch input area and an application selection area, the touch input area being for users to input a touch, and the application selection area being for users to select one or more applications; and
relating a new input touch input through the touch input area to one or more icons of one or more selected applications when the input touch is recognizable, and is neither a use-defined touch of the user-defined touch database nor a system-defined touch.

14. The storage medium as described in claim 13, wherein the operations further comprising:
warning that the input touch input through the touch input area is unrecognizable when the input touch is unrecognizable.

15. The storage medium as described in claim 13, wherein the operations further comprising:
warning that the input touch input through the touch input area is unavailable when input touch is a user-defined touch recorded in the user-defined touch database or a system-defined touch.
